(19) United States
(12) Patent Application Publication
(10) Pub. No.: US 2021/0246576 A1
(43) Pub. Date: Aug. 12, 2021

(54) STRETCHED POLYMERS, PRODUCTS CONTAINING STRETCHED POLYMERS AND THEIR METHOD OF MANUFACTURE

(71) Applicant: RED BANK TECHNOLOGIES LLC, RED BANK, NJ (US)

(72) Inventor: John N. Magno, St. James, NY (US)

(21) Appl. No.: 16/785,998

(22) Filed: Feb. 10, 2020

(51) Int. Cl. D01D 5/12; D01F 6/04; D01D 5/084; D01F 9/12

(52) U.S. Cl. CPC D01D 5/12; D01F 9/12; D01D 5/084; D01F 6/04

(57) ABSTRACT

Disclosed herein are polymer elements, e.g. fibers and tapes, produced by a process consisting of a series of hot drawing steps interspersed with periods of quiescent heating and the process for producing the same. The polymer elements may comprise polyolefin materials such as ultra-high molecular weight polyethylene. The polymer elements may be used to form fabrics or composite materials by themselves or in combination with other polymeric materials.

### BACKGROUND

Theoretical analysis indicates that ultra-high molecular weight polyethylene (UHMWPE) fibers should have tensile strengths of 20 Gpa or greater. Yet commercially available UHMWPE fibers produced by the conventional gel-casting/hot drawing process have only achieved tensile strengths of up to about a fifth of the theoretical value despite great efforts to improve tenacity over more than two decades.

Previous patent applications US2009/0202801 and US2009/0202853 attributed the limitations in strength of gel-spun/hot drawn UHMWPE to the presence of previously undetected “defects” in the fibers that may be visualized by immersing the fiber in refractive index matching fluid and viewing it under illumination with a polarizing microscope. These patent applications pointed out that by avoiding excessive cross-axis stresses imposed on the fibers during processing, the numbers of these defects can be reduced, thus increasing the tenacity of the UHMWPE fibers. However, while the number of defects is reduced by eliminating non-axial stresses, a substantial number of defects remain and appear to be sites at which failure of the fiber occurs under tensile stress.

Accordingly, there is a strong need in the art to further improve the tenacity of fibers by further reduction of the density of defects in the UHMWPE fibers.

### BRIEF DESCRIPTION OF THE DRAWINGS

FIG. 1 illustrates the semi-crystalline microscopic structure of ultra-high molecular weight polyethylene.

FIG. 2 illustrates the infrared absorption spectrum of polyethylene

### DETAILED DESCRIPTION OF THE INVENTION

Further analysis of gel-spun/hot drawn UHMWPE fibers seemed to indicate that the defects that remained in fibers produced using the improved methods of patent applications US2009/0202801 and US2009/0202853 were not micro-cracks in the normal sense, but instead were defects in the crystalline structure, perhaps analogous to dislocations such as occur in three-dimensional crystalline solids. Carrying the analogy further, it is well known that in the case of crystal growth in three-dimensional solids, speeding up the growth rate of crystals by too rapidly cooling the saturated solution from which the crystals are grown or too rapidly moving a molten zone through a boule of the material to be crystallized can result in the proliferation of crystalline defects. In these three-dimensional examples the forcing function in crystal growth that must be applied gradually is temperature change.

In the case of gel-spun/hot drawn UHMWPE fibers it was reasoned that an analogous forcing function in the creation of the highly ordered one-dimensional fiber structures was the mechanical stress imposed on the fiber during the hot drawing process. It was reasoned by analogy that too rapidly increasing the mechanical stress on the fiber during the hot-drawing process would have a similar effect to too rapidly changing the temperature in the case of three-dimensional solids thus proliferating the number of defects in the crystalline fiber structure. But in addition to the applied mechanical stress, heat is also obviously a potential forcing function in the hot drawing process. In order to understand the effect applied mechanical stress and heating during the hot drawing process on defect density, a series of experiments were conducted examining the effect of varying the rate at which these forcing functions were applied over time. One observation that resulted from these experiments was that during the hot drawing process the rate of elongation (strain) versus stress was relatively constant up to a certain level of elongation. At this point in the drawing process the ratio of stress over strain was seen to increase rapidly. In the production of currently commercially available high tensile strength UHMWPE fiber the hot drawing process continues with increasing stress over strain ratio until the desired elongation is achieved. It was further observed that if the drawing process was suspended at a constant low level of stress when the elongation reached the point at which the ratio of stress over strain began to increase rapidly and the fiber was then held for a time at the elevated temperature at which the drawing occurred, the hot drawing of the fiber could then be resumed at a value of the stress over strain ratio similar to that that obtained before the rapid increase in the ratio occurred. After further hot drawing and elongation at the relatively constant stress over strain ratio a rapid increase in this ratio again occurred. Once again the hot drawing process could then be suspended while maintaining the fiber at the elevated temperature of the drawing process and at a constant low level of stress and then a further drawing cycle could be repeated. By cycling between drawing at a relatively low ratio of stress-to-strain and quiescent periods of no strain increase it was possible to achieve fiber elongations similar or higher than those obtained by the current conventional high strength UHMWPE fiber drawing processes used to produce commercial fiber while applying considerably lower values of the mechanical stress forcing function.

When fiber was produced using the above described cyclic process that limited the value of the stress-to-strain ratio, it was found that the number of defects observed in the resulting fiber using a polarizing microscope was greatly reduced. Further, when the fiber produced in this way was tested it was found to have greatly increased tenacity. Thus, a new process has been invented by which very high tenacity materials can be produced by a gel-spinning and hot drawing process.

While it is not possible at this time to definitively elucidate the microscopic processes that lie behind the behavior observed during the above described cyclic drawing process, it is possible to postulate what may be happening. One can postulate that there may be two different mechanisms that can occur when the fiber is placed under stress at elevated temperature. The first results in elongation at relatively low values of stress. The second mechanism results in elongation at higher values of stress. In addition, one can postulate that yet a third more slowly occurring mechanism can take place in the fiber after the low stress drawing process and during the quiescent period at elevated temperature. This third process allows further elongation of the material by the application of a lower value of stress than would otherwise be needed.

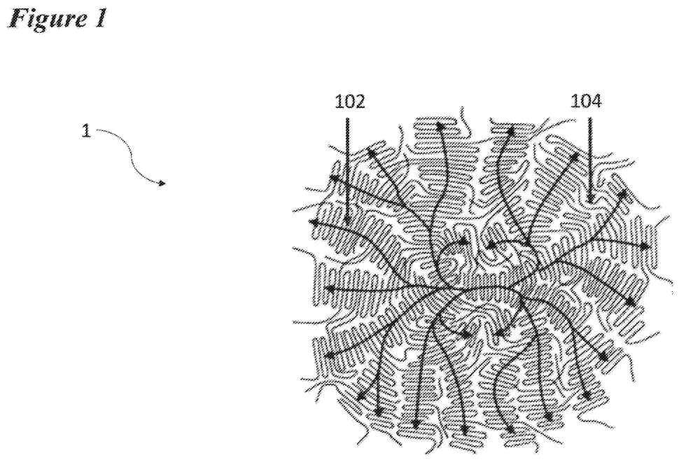

It is well known that the structure of UHMWPE 1 can be semi-crystalline in nature with microscopic regions or lamellae, e.g. 102, in which the polymer chains fold back on themselves in a zig-zag or switchback pattern. Multiple macromolecules can participate in forming a single lamella, e.g. 102, and a single one of the very long UHMWPE molecules can be present in multiple lamella. As shown in FIG. 1 (copied from Wikipedia article https://en.wikipedia.org/wiki/Crystallization_of_polymers), the lamellae, e.g. 102, are connected by regions of amorphous UHMWPE, e.g., 104, with random molecular arrangement. One can postulate that the facile elongation process at low stress-to-strain ratios may involve straightening out the molecular chains in the amorphous regions, e.g., 104, of the semi-crystalline polymer while the process that requires rapidly increasing stress-to-strain ratios is the unravelling of the zig-zag structures of the lamellae, e.g. 102, where considerably higher van der Waals forces between the closely packed molecular segments must be overcome. One can also postulate that as the lamellae, e.g. 102, are unwound, various ordered segments of these structures may “snag” on each other producing the defects that are observed in the conventionally produced UHMWPE fibers.

In order to explain what may be happening in the cyclic drawing process described above, we can once again analogize to the melting and crystallization processes in three-dimensional solids. In a partially melted three-dimensional crystalline solid, there will be interface surfaces between the crystalline solid and the melt. At these surfaces two processes are occurring. In the first process thermal energy is transferred to molecules on the surface of the crystal causing them to leave the crystal into the melt. In the second process molecules from the melt are captured by the crystalline surface giving up their thermal energy on incorporation into the crystal. If the melting process is suspended such that the amount of material in the crystal solid and melt remain constant, then the rates of the two processes must equal each other. If more heat is supplied to the system, more molecules will be transferred from the crystal to the melt. The equilibrium between the crystal and the melt is also governed by the effects of chemical potential. At thermal equilibrium if the chemical potential of the material from the crystalline solid in the melt phase is reduced, e.g. by introducing a small portion of diluting solvent, more molecules must leave the crystalline solid to try to maintain the equilibrium.

In the case of the semi-crystalline UHMWPE, one can postulate a similar equilibrium between the lamellae phase and the amorphous phase. The heat introduced in the hot drawing process increases the transfer of UHMWPE molecular segments from the lamellae phase into the amorphous phase, thus making the drawing process more facile at reasonable values of stress. At first the drawing process is converting the material in the amorphous regions into a third linearly ordered phase. When the drawing process reaches the point at which the stress-to-strain ratio is about to rapidly increase, the amount of the amorphous phase material in the fiber is nearly exhausted. By analogy to the three-dimensional solid, the chemical potential of the amorphous phase is thus considerably reduced. This causes a thermally mediated slow transfer of molecular segments from the lamellae phase into the amorphous phase. Once this transfer has occurred, the drawing process can be resumed at relatively low values of the stress-to-strain ratio and the “snagging” issue produced in unwinding the lamellae is avoided. In other words the third slow process that is postulated to occur in the cyclic hot drawing process described above is the “melting” of the lamellae into the amorphous phase.

A potential issue with introducing the cyclic process described above into the production of ultra-strong UHMWPE fibers is that the process involves a number of quiescent periods in the drawing process that take up time and thus slow the manufacturing process. Further, the fiber needs to be kept under some tension during these quiescent periods with the result that the distance the fiber must travel from one end of the process to the other can be quite long. This means that the footprint of the apparatus used to produce the fiber could be quite large.

In the above postulated microscopic analysis of the cyclic fiber drawing process, it was suggested that during the quiescent periods a thermally mediated “melting” of the lamellae into the amorphous phase was occurring. It seems obvious that if one wished to speed up this slow third process and reduce the size of the apparatus needed, one need only apply heat to the fiber during these quiescent periods. However, one can only heat the UHMWPE fiber so much before it loses it tensile strength altogether or undergoes another form of thermal degradation. Thus there appears to be a need to introduce thermal energy into the fiber in a form that increases the speed of the “melting” process on a microscopic level while not macroscopically damaging the fiber.

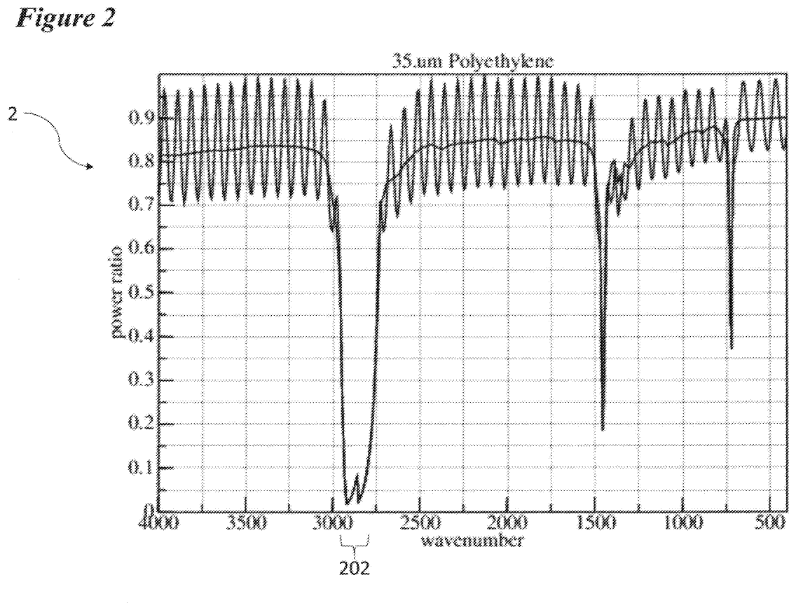

FIG. 2 depicts the infrared spectrum 2 of a typical sample of UHMWPE material. It can be seen that that there is a broad and strong absorption of infrared energy at a wavenumber 202 of 2800 to 2900 cm′ (around 3.5 μm wavelength). It has been found that irradiating the fiber with infrared radiation of that wavelength, for instance by using infrared LED light sources, shortens the time required between the periods of low stress/strain elongation thus reducing the distance the fiber must travel between the periods of elongation.

In a typical example, a solution of approximately 5% UHMWPE and other additives in mineral oil at 180° C. is forced out the bottom of a pressurized vessel through an orifice or spinneret yielding a gel fiber that is cooled in a water bath and then washed with xylene. The xylene washing and subsequent drying yields an aerogel fiber that is then run through a series godets paired with idler rollers arranged and motorized such that the alternating stretching and quiescent tensioned, but non-stretching zones described above are created in the space through which the fiber passes. Heating zones with heat provided by resistive heaters or preferably infrared emitting LEDs are located between the godet/idler roller pairs to heat the fiber in the stretch and quiescent zones.

The cyclic hot drawing process described above can not only be applied to UHMWPE but also to high molecular weight copolymers containing ethylene functional units and also other high molecular weight polyolefins. The cyclic hot drawing process may be used to produce ultra-high strength polymer elements such as tapes as well as fibers.

The fiber produced by the above described cyclic stretching process may be used to produce woven fabrics, non-woven fabric mats, or composite materials comprising the fibers and a polymer matrix. The polymer matrix of the composite materials may comprise thermosetting or thermoplastic materials. For instance, the thermosetting polymer matrices may comprise polymerized epoxy resins, polymerized polyurethane resins, or polymerized resins containing both epoxy and polyurethane functionalities. In particular epoxy resins comprising bisphenol A functionalities (e.g. bisphenol A diglycidyl ether (DGEBA)) and/or bisphenol E reacted with hardeners such as polyamines (e.g. triethylene tetramine (TETA) or N-(2-aminoethyl)-1,3-propanediamine) may be used as polymer matrices. Polyurethane resin matrices containing 4,4′-diphenylmethane diisocyanate (MDI) and/or 1,4-toluene diisocyanate (TDI) functionalities reacted with polyols may be used. Also, polyurethane-modified epoxy resins as described by S. P. Lin, et al. (European Polymer Journal 43 (2007) 996-1008) may be used.

A second type of fiber may be introduced into the woven fabrics, non-woven fabric mats, or composite materials that comprise the fiber produced by the above described cyclic stretching process. For instance, polypropylene fibers may be introduced into woven fabrics, non-woven fabric mats, or composite materials that comprise stretched polyethylene fibers. Carbon fibers, for instance, those produced by pyrolysis of oxidized polyacrylonitrile (PAN), may also be introduced into woven fabrics, non-woven fabric mats, or composite materials that comprise stretched polyethylene fibers.

What is claimed is:

1. A polymer element comprising polymeric material that has been hot drawn by a process that comprises a series of two or more stretching cycles that are interspersed with periods during which the polymer is heated but not stretched or, constant or reduced stretching tension is applied.

2. The polymer element of claim 1 in which the polymeric material has been formed by a gel-spinning process.

3. The polymer element of claim 1 in which the polymer element is a fiber.

4. The polymer element of claim 1 in which the polymer element is a tape.

5. The polymer element of claim 1 in which the polymer element comprises a polyolefin.

6. The polymer element of claim 1 in which the polymer element comprises ultra-high molecular weight polyethylene.

7. The polymer element of claim 1 in which the polymeric material has been hot drawn by a process in which the polymer is irradiated by infrared radiation.

8. The polymer element of claim 7 in which the infrared radiation is produced by a light emitting diode.

9. A process for producing polymer elements in which polymeric material is hot drawn by a process that comprises a series of two or more stretching cycles that are interspersed with periods during which the polymer is heated but not stretched or, constant or reduced stretching tension is applied.

10. The process of claim 9 in which the polymeric material has been formed by a gel-spinning process.

11. The process of claim 9 in which the polymer element comprises ultra-high molecular weight polyethylene.

12. A fabric comprising the fibers of claim 3.

13. A composite material comprising polymer elements of claim 1.

14. The composite material of claim 13 further comprising a polymer matrix.

15. The composite material of claim 14 wherein the polymer matrix comprises polymerized epoxy functionalities.

16. The composite material of claim 14 wherein the polymer matrix comprises polymerized urethane functionalities.

17. The composite material of claim 13 further comprising a fiber comprising a second polymer material.

18. The composite material of claim 17 wherein the fiber comprising a second polymer material is a carbon fiber.
